(19) United States
(12) Patent Application Publication
(10) Pub. No.: US 2026/0249962 A1
(43) Pub. Date: Aug. 27, 2026

(54) AUTONOMOUS ROAMING OFFSHORE WIND TURBINE

(71) Applicants: University of Maine System Board of Trustees, Orono, ME (US); Alliance for Sustainable Energy, LLC, Golden, CO (US)

(72) Inventors: Richard W. Kimball, Orono, ME (US); Andrew J. Goupee, Orono, ME (US); Anthony M. Viselli, Orono, ME (US); Habib J. Dagher, Orono, ME (US); Walter D. Musial, Boulder, CO (US); Amy N. Robertson, Golden, CO (US); Fredrick R. Driscoll, Golden, CO (US)

(73) Assignees: University of Maine System Board of Trustees, Orono, ME (US); Alliance for Sustainable Energy, LLC, Golden, CO (US)

(21) Appl. No.: 18/844,537

(22) PCT Filed: Mar. 23, 2023
(86) PCT No.: PCT/US2023/016056

§ 371 Date: Sep. 6, 2024

(51) Int. Cl. B63B 35/44; B63B 1/24; B63B 39/06; B63B 41/00; F03D 13/25

(52) U.S. Cl. CPC B63B 35/44; B63B 1/246; B63B 39/06; B63B 41/00; F03D 13/256; B63B 2035/446; B63B 2035/4486; F05B 2240/93

(57) ABSTRACT

An autonomous roaming offshore wind turbine (AROWT) includes a floating hull, a lifting keel extending outwardly from an under-side of the hull, ballast, a propeller mounted to a portion of the hull, and a wind turbine mounted to an upper side of the hull. When deployed in a body of water, the AROWT moves in a figure-eight station-keeping pattern and includes: a wind turbine having a rated power between 5 MW and 25 MW, a rated wind speed between 8 m/s and 20 m/s, a wind turbine blade diameter within 100 m to 300 m, a lifting keel depth of between 30 m and 100 m, a hull speed to wind speed ratio of between 0.1 and 0.3, a pattern beam to wind turbine blade diameter ratio of between 0.5 and about 5.0, and a pattern beam to pattern surge ratio of between 0.02 and about 0.1

### CROSS-REFERENCE TO RELATED APPLICATIONS

This application claims the benefit of U.S. Provisional Application No. 63/322,791, filed Mar. 23, 2022, the disclosure of which is incorporated herein by reference.

### CONTRACTUAL ORIGIN

This invention was made with United States government support under Contract No. DE-AC36-08GO28308 awarded by the U.S. Department of Energy. The United States government has certain rights in this invention.

### BACKGROUND OF THE INVENTION

This invention relates in general to floating wind turbine platforms. In particular, this invention relates to an improved autonomous roaming offshore wind turbine (AROWT) that is free to chase wind energy anywhere in the ocean.

Wind turbines for converting wind energy to electrical power are known and provide an alternative energy source for power companies. On land, large groups of wind turbines, often numbering in the hundreds of wind turbines, may be placed together in one geographic area. These large groups of wind turbines can generate undesirably high levels of noise and may be viewed as aesthetically unpleasing. An optimum flow of air may not be available to these land-based wind turbines due to obstacles such as hills, woods, and buildings.

Groups of wind turbines may also be located offshore, but near the coast at locations where water depths allow the wind turbines to be fixedly attached to a foundation on the seabed. Over the ocean, the flow of air to the wind turbines is not likely to be disturbed by the presence of various obstacles (i.e., as hills, woods, and buildings) resulting in higher mean wind speeds and more power. The foundations required to attach wind turbines to the seabed at these near-coast locations are relatively expensive, and can only be accomplished at relatively shallow depths, such as a depth of up to about 45 meters.

The U.S. National Renewable Energy Laboratory has determined that winds off the U.S. Coastline over water having depths of 30 meters or greater have an energy capacity of about 3,200 TWh/yr. This is equivalent to about 90 percent of the total U.S. energy use of about 3,500 TWh/yr. The majority of the offshore wind resource resides between 37 and 93 kilometers offshore where the water is over 60 meters deep. Fixed foundations for wind turbines in such deep water are likely not economically feasible. This limitation has led to the development of floating platforms for wind turbines.

Known floating offshore wind turbines (FOWTs) allow for the capture of abundant high-energy winds in deep water, but require costly foundations, moorings, and anchors, and have high operation and maintenance costs. The National Renewable Energy Laboratory (NREL) estimates that operations and maintenance, foundations, electrical infrastructure, assembly, and installation alone account for over 68 percent of a FOWT's levelized cost of energy (LCOE).

It would be desirable therefore to provide a floating wind turbine platform that can autonomously roam, thus eliminating the need for floating wind farms that must operate as fixed power-generation stations.

### SUMMARY OF THE INVENTION

This invention relates to an improved autonomous roaming offshore wind turbine (AROWT) that is free to chase wind energy anywhere in the ocean. In one embodiment, the AROWT includes a floating hull, a lifting keel extending outwardly from an underside of the hull, ballast, a propeller mounted to a portion of the hull, and a wind turbine mounted to an upper side of the hull. When deployed in a body of water, the AROWT moves in a figure-eight station-keeping pattern and includes: a wind turbine having a rated power between 5 MW and 25 MW, a rated wind speed between 8 m/s and 20 m/s, a wind turbine blade diameter within 100 m to 300 m, a lifting keel depth of between 30 m and 100 m, a hull speed to wind speed ratio of between 0.1 and 0.3, a pattern beam to wind turbine blade diameter ratio of between 0.5 and about 5.0, and a pattern beam to pattern surge ratio of between 0.02 and about 0.1.

In a second embodiment, the AROWT includes a floating hull, a lifting keel extending outwardly from an underside of the hull, ballast, a propeller mounted to a portion of the hull, and a wind turbine mounted to an upper side of the hull. When deployed in a body of water, the AROWT moves in a figure-eight station-keeping pattern and includes: a wind turbine having a rated power between 5 MW and 25 MW, a rated wind speed between 8 m/s and 20 m/s, a wind turbine blade diameter within 100 m to 300 m, a lifting keel depth of between 30 m and 100 m, a hull speed to wind speed ratio of between 0.05 and 0.5, a pattern beam to wind turbine blade diameter ratio of between 0.5 and about 10.0, and a pattern beam to pattern surge ratio of between 0.01 and about 0.5.

In a third embodiment, the AROWT includes a floating hull, a lifting keel extending outwardly from an underside of the hull, ballast, a propeller mounted to a portion of the hull, and a wind turbine mounted to an upper side of the hull. When deployed in a body of water, the AROWT moves in a figure-eight station-keeping pattern and includes: a wind turbine having a rated power between 5 MW and 25 MW, a rated wind speed between 8 m/s and 20 m/s, a wind turbine blade diameter within 100 m to 300 m, a lifting keel depth of between 30 m and 100 m, a hull speed to wind speed ratio of between 0.05 and 0.5, a pattern beam to wind turbine blade diameter ratio of between 0.5 and about 10.0, and a pattern beam to pattern surge ratio of between 0.01 and about 1.0.

In a fourth embodiment, the AROWT includes a floating hull, a lifting keel extending outwardly from an underside of the hull, ballast, a propeller mounted to a portion of the hull, and a wind turbine mounted to an upper side of the hull. When deployed in a body of water, the AROWT moves in a figure-eight upwind travel pattern at an upwind travel velocity.

In a fifth embodiment, the AROWT includes a floating hull, a lifting keel extending outwardly from an underside of the hull, ballast, a propeller mounted to a portion of the hull, and a wind turbine mounted to an upper side of the hull. When deployed in a body of water, the AROWT moves in a figure-eight downwind travel pattern at a downwind travel velocity.

Various aspects of this invention will become apparent to those skilled in the art from the following detailed description of the preferred embodiment, when read in view of the accompanying drawings.

### BRIEF DESCRIPTION OF THE DRAWINGS

FIG. 1 is a perspective view of an autonomous roaming offshore wind turbine (AROWT) in accordance with this invention.

FIG. 2 is an elevational view of the AROWT illustrated in FIG. 1.

FIG. 3 is an illustration of a first embodiment of a station-keeping pattern for the AROWT illustrated in FIGS. 1 and 2.

FIG. 4 is an illustration of a second embodiment a station-keeping pattern showing the AROWT illustrated in FIGS. 1 and 2 in an upwind travel pattern.

FIG. 5 is an illustration of a third embodiment a station-keeping pattern showing the AROWT illustrated in FIGS. 1 and 2 in a downwind travel pattern.

### DETAILED DESCRIPTION OF THE PREFERRED EMBODIMENT

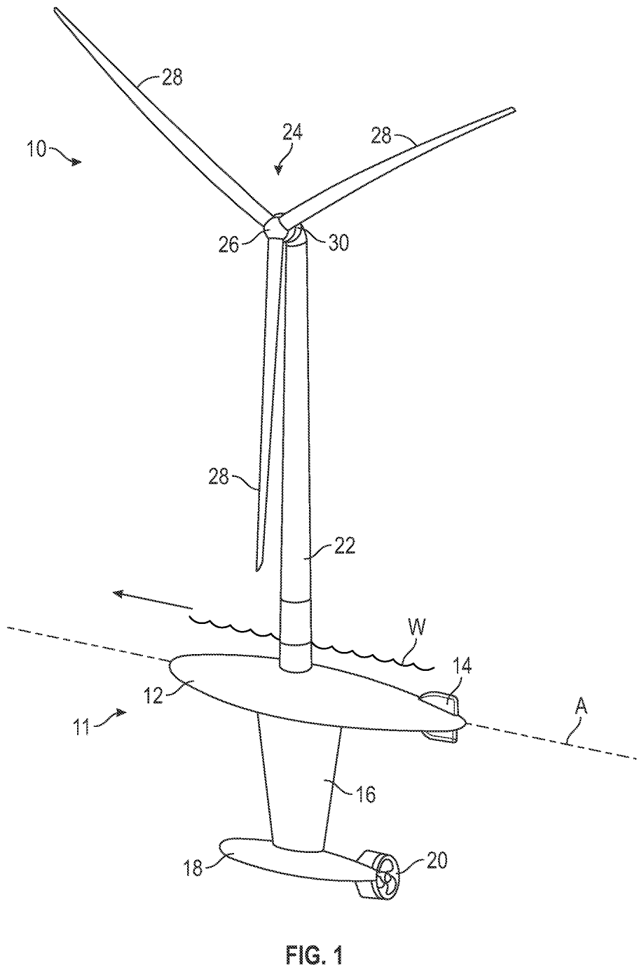

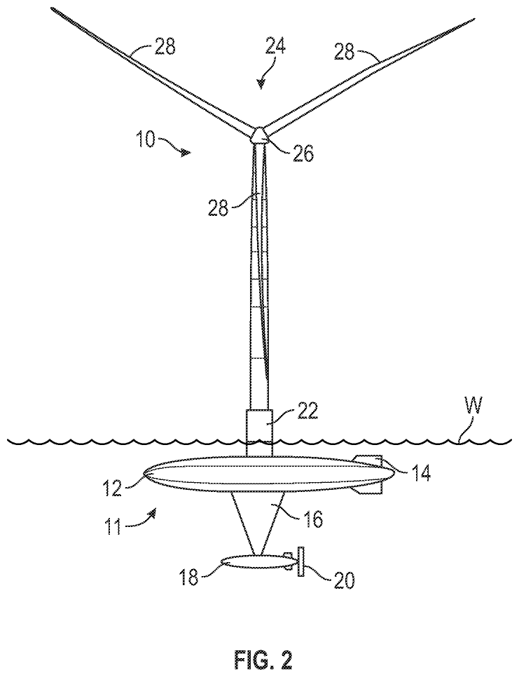

Referring now to the drawings, there is illustrated in FIGS. 1 and 2 a first embodiment of an autonomous roaming offshore wind turbine (AROWT) 10 according to this invention. The embodiments of the large AROWT 10 described herein are configured to operate independently such that they are free to chase wind energy anywhere in the ocean, including international waters. Thus, the use of the AROWT 10 has the potential to significantly increase renewable energy capture worldwide.

The AROWT 10 includes a foundation or hull 11 that includes an elongated torpedo-shaped buoyancy, equipment, and storage tank defining an upper hull 12 having a pair of vertically oriented control fins 14, a lifting keel 16, and an elongated torpedo shaped ballast pod 18. The upper hull 12 may include one or more internal compartments (not shown), such as buoyancy compartments, which may be filled or partly filled with water to control buoyancy and stability. The buoyancy compartments within the upper hull 12 may be used as ballast tanks, or may be used to store liquid fuel, for example, hydrocarbons, hydrogen, ammonia, and the like, that are created by production equipment (not shown) onboard the AROWT 10 and the energy captured by a conventional wind turbine 24, such as a 15 MW wind turbine, mounted to an upper end of the upper hull 12. Advantageously, the buoyancy compartments within the upper hull 12 comprise a majority of the internal volume required to maintain system buoyancy and stability of the entire AROWT 10. It will be understood that the lifting keel 16 and the ballast pod 18 may also include one or more internal compartments (not shown), that may be used to store liquid fuel, for example, hydrocarbons, hydrogen, ammonia, and the like, that are created by production equipment (not shown) onboard the AROWT 10.

The lifting keel 16 is aligned with a longitudinal axis A of the upper hull 12 and extends outwardly therefrom (downwardly when viewing FIGS. 1 and 2). In the embodiment of the AROWT 10 shown in FIGS. 1 and 2 and having the 15 MW wind turbine 24, the lifting keel 16 has vertical length of about 50 m. Alternatively, the lifting keel 16 may have a vertical length within the range of about 10 m to about 100 m. As used herein, the lifting keel 16 is defined as the principal central longitudinal structural member and subsea lifting surface of the AROWT 10, and is positioned at, or close to, the lowest point of the upper hull 12. The lifting keel 16 extends outwardly from a lower outer surface of the upper hull 12 and provides hydrodynamic lift forces that act to resist thrust forces of the wind turbine 24 that generate net forces that drive the AROWT 10 in a desired and prescribed pattern. The hull 11, including the upper hull 12, the lifting keel 16, and the ballast pod 18 may be formed from metal, such as steel, marine grade composites, and marine grade concrete materials.

The ballast pod 18 is attached to a distal end of the lifting keel 16 and includes a propulsor or a propeller 20 at an aft end thereof. For use with the illustrated 15 KW wind turbine 24, the propeller 20 may have a diameter within the range of about 0.5 m to about 5 m in diameter, and may have a size of about 0.02 percent to about 0.05 percent of a diameter of wind turbine blades 28, described below, and designed and configured to produce propulsive power between about 8 percent and about 40 percent of the rated power of the wind turbine 24. The ballast pod 18 provides stability and additional hydrodynamic resistance effects. The ballast pod 18 may include one or more internal ballast compartments (not shown) which may be filled or partly filled with a heavy ballast material (not shown) to provide stability. The ballast material may be moveable material, such as gravel or stones that are permanently or semi-permanently installed therein, and may be a combination of water and other heavy solid ballast materials such as iron ore, lead, steel, and aggregates, such as sand and stones. The ballast material may also be integral to the ballast pod 18, such as for example, the ballast pod 18 may be formed from metal, such as steel, marine grade composites, and marine grade concrete materials. Ballast in the ballast pod may be a combination of water, and other heavy solid ballast materials such as iron ore, aggregates (sand, rocks), lead, steel.

The upper hull 12 also supports a conventional wind turbine tower 22, described below. The wind turbine tower 22 extends outwardly from the upper hull 12 opposite the lifting keel 16 (upwardly when viewing FIGS. 1 and 2) and includes the conventional wind turbine 24 mounted to an upper end thereof. The wind turbine 24 is structured and configured such that it has the ability to yaw, thereby allowing the orientation of the wind turbine 24 to be changed relative to the direction of the longitudinal axis A of the upper hull 12.

In the illustrated embodiment, the tower 22 is tubular having an outer wall defining a hollow interior space, and may have any suitable outside diameter and height. For example, for the 15 MW wind turbine 24 shown in FIGS. 1 and 2, the tower 22 may have a height of about 150 m. It will be understood that the height of the tower 22 may vary based on the size of the wind turbine 24 mounted thereon. In the illustrated embodiment, the outside diameter of the tower 22 tapers from a first diameter at its base to a second, smaller diameter at its upper end. The illustrated tower 22 may be formed from fiber reinforced polymer (FRP) composite material. Non-limiting examples of other suitable composite materials include glass and carbon FRP. The tower may also be formed from a composite laminate material. Alternatively, the tower 22 may also be formed from concrete or steel. The tower 22 may be formed in any number of sections (not shown).

In the embodiment illustrated herein, the wind turbine 24 is a horizontal-axis wind turbine. Alternatively, the wind turbine may be a vertical-axis wind turbine (not shown). The size of the wind turbine 24 may vary based on the wind conditions at the location or locations where the AROWT 10 is operating and the desired power output. For example, the wind turbine 24 may have an output of about 15 MW. Alternatively, the wind turbine 24 may have a rated power output within the range of from about 1 MW to about 25 MW capable of operating in wind speeds of between about 4 m/s and 20 m/s.

The wind turbine 24 includes a rotatable hub 26. At least one wind turbine blade 28 is coupled to and extends outward from the hub 26. The hub 26 is rotatably coupled to a nacelle 30 which is attached aft of the wind turbine 24, and which houses the electrical and mechanical components of the wind turbine 24, such as an electric generator (not shown). The electric generator may be coupled to equipment (not shown) within the upper hull 12. In the illustrated embodiment, the hub 26 has three wind turbine blades 28 attached and defining a wind turbine blade diameter. In other embodiments, the hub 26 may have more or less than three wind turbine blades 28. The wind turbine blades 28 may have a diameter within the range of about 50 m to about 300 m.

The upper hull 12 is semi-submersible, and is structured and configured to float, semi-submerged, in a body of water. The upper hull 12 of the AROWT 10 may float only partially submerged (not shown) or fully submerged, such that the waterline W of the body of water in which the AROWT 10 is floating is at the base of the tower 22, as shown in FIGS. 1 and 2.

Although not shown, a simpler embodiment of the AROWT 10 may include the wind turbine 24 and its associated tower 22 mounted atop a hull that includes a keel lifting surface, similar to the upper hull 12 and the lifting keel 16, and one or more independently driven propulsors, similar to the propulsor 20, but mounted aft of the hull.

Advantageously, the electricity generated onboard the AROWT 10 having, for example, a state of the art 10 to 15 MW upwind, horizontal-axis wind turbine, may be used for multiple purposes. The electricity generated may be used, for example, for carbon sequestration, hydrogen production, and/or the manufacture of carbon-free liquid ammonia (NH₃), the primary chemical used to make fertilizer, or other desired products. The AROWT 10 is configured to slowly navigate the ocean and use autonomous shipping technology and novel sailing principals to seek out the most productive winds and enhance energy capture.

The modified, keel-shaped configuration of the hull 11 of the AROWT 10, provides sufficient stability to resist overturning moments from wind forces, enables efficient navigation, and energy harvesting, and also provides on-board storage for manufactured fuels. Although the hull 11 is shown as having a keel-shaped configuration, it will be understood that the foundation may have other semi-submersible configurations.

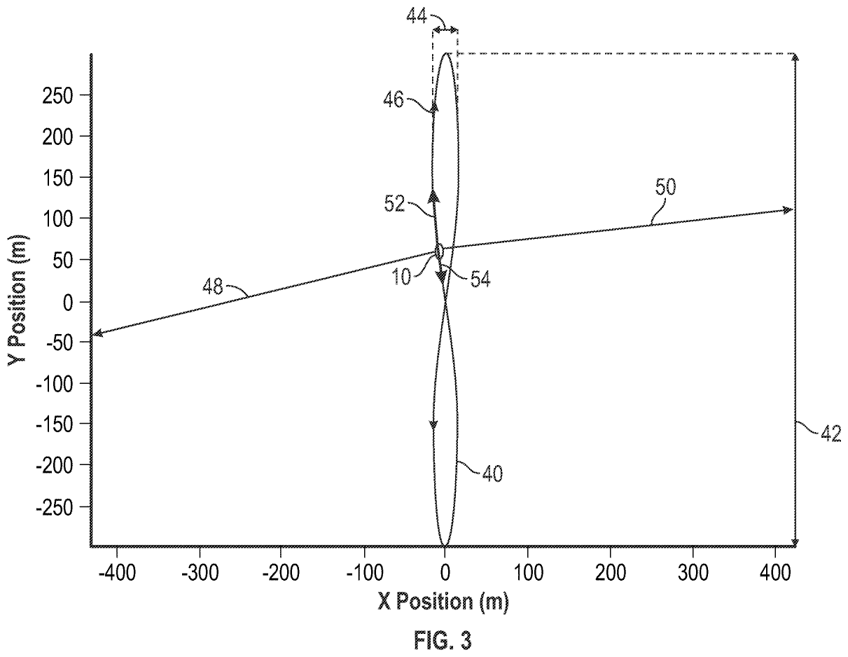

Referring now to FIG. 3, one embodiment of an AROWT 10 station-keeping pattern is shown. As shown, the AROWT 10 maximizes energy capture and resists turbine thrust without a mooring system. In FIG. 3, the AROWT 10 is shown in a figure-eight station-keeping pattern 40. In the illustrated embodiment, a pattern beam 42 is defined as a width of the station-keeping pattern generally transverse to a direction of the wind, shown at WS. A pattern surge 44 is defined as the extent of movement of the AROWT 10 within the path 40 in the direction of the wind WS. Hull speed is shown by the arrow 46, wind turbine 24 thrust is shown by the arrow 48, and lifting keel 16 lift is shown by the arrow 50. The pattern beam 42 may be further defined as a distance equal to about 0.5 to about 10 times the diameter of the wind turbine blades 28. The pattern beam 42 may also be defined as a distance greater than about 10 times the diameter of the wind turbine blades 28. In operation, the hull speed 46 to wind speed WS ratio is within the range of about 0.1 to about 0.3. Alternatively, the hull speed 46 to wind speed WS ratio may be within the range of about 0.05 to about 0.5. In operation, the pattern surge 44 to pattern beam 42 ratio may be within the range of about 0.02 to about 0.1. Alternatively, the pattern surge 44 to pattern beam 42 ratio may be within the range of about 0.01 to about 0.5 or within the range of about 0.01 to about 1.0.

As used herein, AROWT travel patterns, including holding patterns, upwind travel patterns, and downwind travel patterns, are comprised of travel patterns shaped generally as a figure-eight style pattern, wherein a path of the AROWT 10 crosses itself somewhere near a mid-point of the pattern. When in the energy production regions of the pattern, the general motion of the AROWT 10 is in a somewhat downwind direction, and when in a tacking portion of the pattern, the AROWT 10 travels generally upwind.

Referring again to FIG. 3, propeller 20 thrust is shown by the arrow 52. For the figure-eight station-keeping pattern 40 shown in FIG. 3, the wind turbine 24 vector has a small drag component, shown by the arrow 54, that adds to the AROWT 10 drag. The propeller 20 is needed to counter these drag forces 54. However, the wind turbine 24 will experience a small increase in apparent wind which may increase output to counter some of the propeller 20 power required. With forward speed, the lifting keel 16 creates the keel lift 50 which counteracts the turbine thrust 48, minimizing downwind motion and maximizing the relative wind speed, which in turn increases energy capture. When briefly traveling upwind, energy is used by the propeller 20 to rotate the hull 11.

It has been shown using a hydro/aerodynamic vector model of the AROWT 10 illustrated in FIGS. 1 and 2, using a commercially available 15 MW wind turbine 24, and assuming a 70 percent efficient propeller 20, that the figure-eight station-keeping pattern 40, as shown in FIG. 3, only requires consumption of 10 to 15 percent of the wind turbine's 24 energy for an optimally configured system (represented by the AROWT 10) with realistic performance. The AROWT 10 may be optimized further by traveling larger distances, reducing wind turbine power while executing turns, vectoring the wind turbine thrust 48 with yaw, optimizing route path 40 and hull speed 46, including weather variation control feedback, and the like. Thus, it has been shown that the AROWT 10 system efficiency may be substantially improved through optimization in the proposed effort.

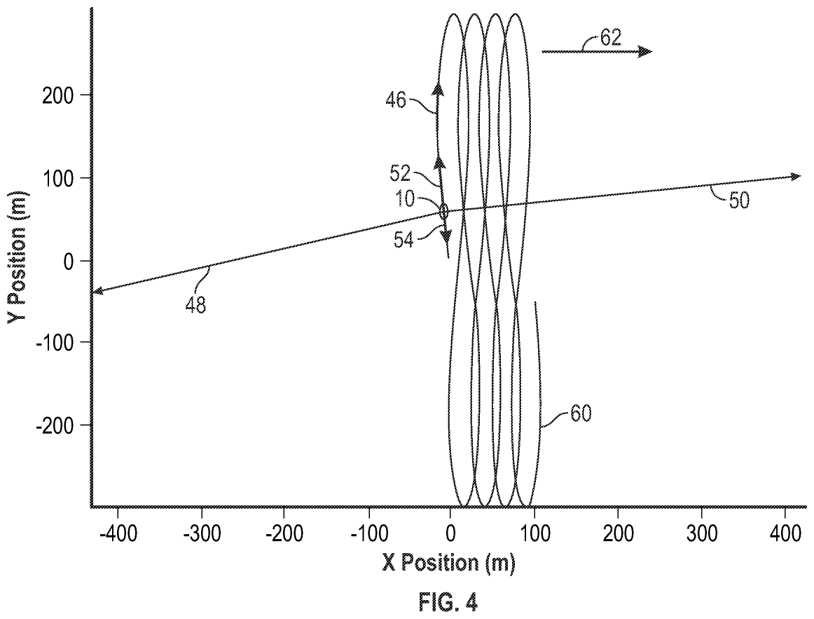

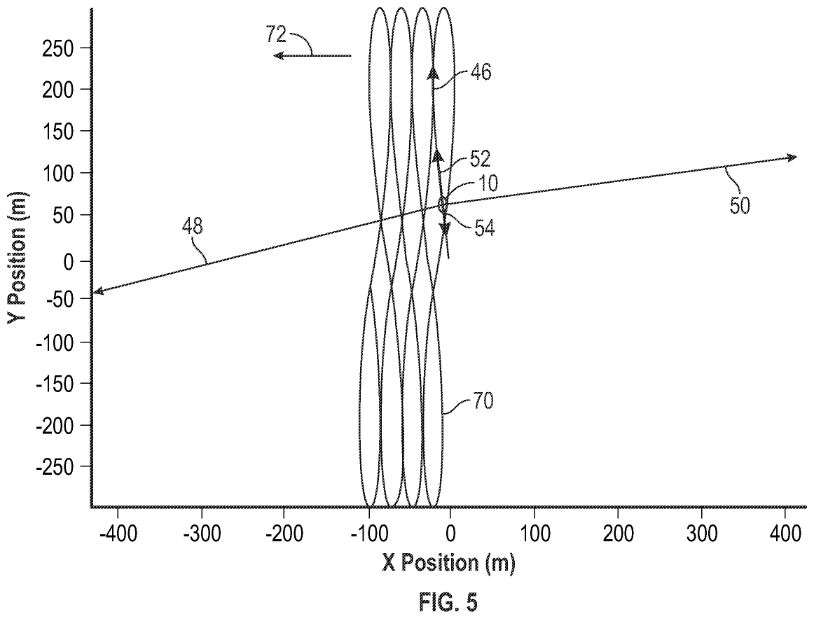

The unique combination of the AROWT 10 configuration combined with the novel station keeping pattern 40 illustrated in FIG. 3, allows the AROWT 10 to produce significant energy, i.e., electricity, from the wind turbine 24 and control the AROWT 10 without the use of mooring lines or anchors. Although this pattern 40 and vector manipulations using the lifting keel 16, wind turbine 24 and propeller 20 is similar in principle to the operation of a sailboat, the operation of the vectoring elements, including the lifting keel 16, the propeller 20, and the wind turbine 24, differs greatly from a conventional sailing tacking maneuver. This difference is because the major forces delivered by the wind turbine 24, including downwind thrust, are very different from a sail's lift forces, which are perpendicular to the wind. Therefore, the station keeping pattern 40 illustrated in FIG. 3, and the alternate embodiments shown in FIGS. 4 and 5 and described below, are novel and unique to the successful operation and power production of the AROWT 10 system. Although the AROWT 10 operating in the station keeping pattern 40 illustrated in FIG. 3 has been described as operating without the use of mooring lines or anchors, it will be understood that the AROWT 10 may operate in the station keeping pattern 40, or in the alternate embodiments of the travel patterns shown in FIGS. 4 and 5, while anchored.

In the embodiment of the station keeping pattern 40 illustrated in FIG. 3, the AROWT 10 is shown in a body water and has no permanent moorings that attach the AROWT 10 to the seabed. The illustrated figure-eight pattern 40 may have the following characteristics: a wind turbine 24 having a rated power between about 5 MW to about 25 MW, a rated wind speed WS of between 8 m/s and about 20 m/s, a wind turbine blade diameter within the range of about 100 m to about 300 m, a lifting keel 16 depth of between about 30 m to about 100 m, a hull speed 46 to wind speed WS ratio of between about 0.1 to about 0.3, a pattern beam 42 to wind turbine blade diameter ratio of between 0.5 to about 5.0, and a pattern beam 42 to pattern surge 44 ratio of between 0.02 to about 0.1, defining an optimal pattern beam 42 to pattern surge 44 ratio.

Alternatively, the figure-eight pattern 40 illustrated in FIG. 3 may have the following characteristics: a wind turbine 24 have rated power between about 5 MW to about 25 MW, a rated wind speed WS of between 8 m/s and about 20 m/s, a wind turbine blade diameter within the range of about 100 m to about 300 m, a lifting keel 16 depth of between about 30 m to about 100 m, a hull speed 46 to wind speed WS ratio of between about 0.05 to about 0.5, a pattern beam 42 to wind turbine blade diameter ratio of between 0.5 to about 10.0, and a pattern beam 42 to pattern surge 44 ratio of between 0.01 to about 0.5, defining an operational pattern beam 42 to pattern surge 44 ratio.

Additionally, the figure-eight pattern 40 illustrated in FIG. 3 may have the following characteristics: a wind turbine 24 have rated power between about 5 MW to about 25 MW, a rated wind speed WS of between 8 m/s and about 20 m/s, a wind turbine blade diameter within the range of about 100 m to about 300 m, a lifting keel 16 depth of between about 30 m to about 100 m, a hull speed 46 to wind speed WS ratio of between about 0.05 to about 0.5, a pattern beam 42 to wind turbine blade diameter ratio of between 0.5 to about 10.0, and a pattern beam 42 to pattern surge 44 ratio of between 0.01 to about 1.0, defining a functional pattern beam 42 to pattern surge 44 ratio.

Referring now to FIG. 4, a second embodiment of an AROWT 10 station-keeping pattern is shown. As shown, the AROWT 10 maximizes energy capture and resists turbine thrust without a mooring system. In FIG. 4, the AROWT 10 is shown in a figure-eight upwind travel pattern 60. The pattern 60 is similar to the pattern 40, but the AROWT 10 moves upwind at an upwind travel velocity 62. The illustrated upwind travel pattern 60 may be used when a net upwind hull speed to wind speed WS ratio is within the range of about 0.001 to about 0.2. Alternatively, the illustrated upwind travel pattern 60 may be used when a net upwind hull speed to wind speed WS ratio is within the range of about 0.001 to about 0.4.

Referring now to FIG. 5, a third embodiment of an AROWT 10 station-keeping pattern is shown. As shown, the AROWT 10 maximizes energy capture and resists turbine thrust without a mooring system. In FIG. 5, the AROWT 10 is shown in a figure-eight downwind travel pattern 70. The pattern 70 is similar to the pattern 60, but the AROWT 10 moves downwind at a downwind travel velocity 72. The illustrated downwind travel pattern 70 may be used when a net downwind hull speed to wind speed WS ratio is within the range of about 0.001 to about 0.2. Alternatively, the illustrated upwind travel pattern 70 may be used when a net downwind hull speed to wind speed WS ratio is within the range of about 0.001 to about 0.4.

Advantageously, the AROWT 10 may produce more energy than other offshore wind turbines. Although the AROWT 10 may lose some power produced so that it may supply the power necessary for the operation of its propeller 20, and may lose some power associated with chemical fuel production, these losses may be offset because the AROWT 10 can access better winds far offshore, adapt to seasonal weather changes, avoid unfavorable weather, and avoid wake and transmission losses. In addition, the cost of the energy generated by the AROWT 10 may be significantly reduced through the elimination of most government permits, construction at sea, grid, transformers, convertors, moorings, and anchors associated with conventional floating offshore wind turbines (FOWTs). Referring to the example of on-board NH₃ production, energy may be generated at capital costs that are about 40 percent lower than conventional offshore wind energy production. Also, the AROWT 10 allows energy production in areas where moored offshore wind will not work, for example, namely very deep water, such as water having a depth greater than about 1500 m, which is the depth of water in a large percentage of the world's oceans.

Advantageously, purified seawater may be electrolyzed into hydrogen (H₂) and then to higher density NH₃ to facilitate onboard storage. Service ships may be dispatched to retrieve the stored NH₃ at specified times and locations throughout the year, when and where ocean conditions are benign. Small modular NH₃ plants may be mass produced to reduce costs and integrated into the one or more of the buoyancy compartments (not shown) of the upper hull 12. This concept has the potential to be a very low cost method of producing carbon-free NH₃ while eliminating hazardous siting concerns associated with on-shore NH₃ production. NH₃ is not only an energy source but also a large source of commercial fertilizers, and significant pipeline transport infrastructure for NH₃ already exists in the US. Additionally, potential revenues from NH₃ generation are tied to world market prices for NH₃, which is currently derived from supplies of methane and coal. The use of the AROWT 10 for NH₃ production may change the reliance on fossil fuels as a feedstock for NH₃ production.

Although it is conventionally understood that FOWT farms must be geographically fixed power-generating stations, the floating but autonomously roaming AROWT 10 described herein may significantly reduce or eliminate many of the costs associated with fabricating, installing, and operating an offshore wind installation. Significantly, the AROWT 10 may achieve significant reductions in energy generation costs by: eliminating costly foundations, moorings, and anchors, and the associated geotechnical work and installation thereof; using lighter, more efficient hulls or foundations relative to stationary FOWTs; no longer requiring electrical cable infrastructure; reducing the cost of permits, for example by shifting oversight and regulatory control from the Bureau of Ocean Energy Management (BOEM) to the Coast Guard; and providing an increased capacity factor resulting from the capability of autonomous navigation to high-energy wind sites.

Additionally, the AROWTs 10 have several environmental benefits over known technologies, such as known FOWTs, including: having fewer competing issues, for example fishing conflicts may be eliminated; having no anchors, electrical cables, or other equipment that may be left at sea after the project life is complete, and by having lighter hulls that use less material.

The principle and mode of operation of this invention have been explained and illustrated in its preferred embodiment. However, it must be understood that this invention may be practiced otherwise than as specifically explained and illustrated without departing from its spirit or scope.

What is claimed is:

1. An autonomous roaming offshore wind turbine (AROWT) comprising:
a floating hull;
a lifting keel extending outwardly from an underside of the hull;
ballast;
a propeller mounted to a portion of the hull; and
a wind turbine mounted to an upper side of the hull opposite the underside thereof;
wherein when deployed in a body of water, the AROWT moves in a figure-eight station-keeping pattern; and
wherein when moving in the figure-eight station-keeping pattern, the AROWT includes:
a wind turbine having a rated power between 5 MW and 25 MW;
a rated wind speed of between 8 m/s and 20 m/s;
a wind turbine blade diameter within the range of 100 m to 300 m;
a lifting keel depth of between 30 m and 100 m;
a hull speed to wind speed ratio of between 0.1 and 0.3 ;
a pattern beam to wind turbine blade diameter ratio of between 0.5 and about 5.0; and
a pattern beam to pattern surge ratio of between 0.02 and about 0.1.

2. The AROWT according to claim 1, wherein the AROWT is floating in a body water and has no moorings that attach the AROWT to a seabed.

3. The AROWT according to claim 1, wherein the floating hull includes a tank defining an upper hull, and wherein the lifting keel extends outwardly from an underside of the upper hull.

4. The AROWT according to claim 1, wherein the wind turbine and production equipment within the floating hull are configured to produce liquid ammonia (NH₃) from seawater and store the NH₃ in a compartment within the floating hull.

5. The AROWT according to claim 1, further including an elongated torpedo shaped ballast pod attached to a distal end of the lifting keel.

6. The AROWT according to claim 5, further including a propeller mounted at an aft end of the ballast pod.

7. An autonomous roaming offshore wind turbine (AROWT) comprising:
a floating hull;
a lifting keel extending outwardly from an underside of the hull;
ballast;
a propeller mounted to a portion of the hull; and
a wind turbine mounted to an upper side of the hull opposite the underside thereof;
wherein when deployed in a body of water, the AROWT moves in a figure-eight station-keeping pattern; and
wherein when moving in the figure-eight station-keeping pattern, the AROWT includes:
a wind turbine having a rated power between 5 MW and 25 MW;
a rated wind speed of between 8 m/s and 20 m/s;
a wind turbine blade diameter within the range of 100 m to 300 m;
a lifting keel depth of between 30 m and 100 m;
a hull speed to wind speed ratio of between 0.05 and 0.5;
a pattern beam to wind turbine blade diameter ratio of between 0.5 and 10.0; and
a pattern beam to pattern surge ratio of between 0.01 and 0.5.

8. The AROWT according to claim 7, wherein the AROWT is floating in a body water and has no moorings that attach the AROWT to a seabed.

9. The AROWT according to claim 7, wherein the floating hull includes a tank defining an upper hull, and wherein the lifting keel extends outwardly from an underside of the upper hull.

10. The AROWT according to claim 9, wherein the wind turbine and production equipment within the floating hull are configured to produce liquid ammonia (NH₃) from seawater and store the NH₃ in a compartment within the floating hull.

11. The AROWT according to claim 7, further including an elongated torpedo shaped ballast pod attached to a distal end of the lifting keel.

12. The AROWT according to claim 11, further including a propeller mounted at an aft end of the ballast pod.

13. An autonomous roaming offshore wind turbine (AROWT) comprising:
a floating hull;
a lifting keel extending outwardly from an underside of the hull;
ballast;
a propeller mounted to a portion of the hull; and
a wind turbine mounted to an upper side of the hull opposite the underside thereof;
wherein when deployed in a body of water, the AROWT moves in a figure-eight station-keeping pattern; and
wherein when moving in the figure-eight station-keeping pattern, the AROWT includes:
a wind turbine having a rated power between 5 MW and 25 MW;
a rated wind speed of between 8 m/s and 20 m/s;
a wind turbine blade diameter within the range of 100 m to 300 m;
a lifting keel depth of between 30 m and 100 m;
a hull speed to wind speed ratio of between 0.05 and 0.5;
a pattern beam to wind turbine blade diameter ratio of between 0.5 and 10.0; and
a pattern beam to pattern surge ratio of between 0.01 and 1.0.

14. The AROWT according to claim 13, wherein the AROWT is floating in a body water and has no moorings that attach the AROWT to a seabed.

15. The AROWT according to claim 13, wherein the floating hull includes a tank defining an upper hull, and wherein the lifting keel extends outwardly from an underside of the upper hull.

16. The AROWT according to claim 15, wherein the wind turbine and production equipment within the floating hull are configured to produce liquid ammonia (NH₃) from seawater and store the NH₃ in a compartment within the floating hull.

17. The AROWT according to claim 13, further including an elongated torpedo shaped ballast pod attached to a distal end of the lifting keel.

18. The AROWT according to claim 17, further including a propeller mounted at an aft end of the ballast pod.

19. An autonomous roaming offshore wind turbine (AROWT) comprising:
a floating hull;
a lifting keel extending outwardly from an underside of the hull;
ballast;
a propeller mounted to a portion of the hull; and
a wind turbine mounted to an upper side of the hull opposite the underside thereof;
wherein when deployed in a body of water, the AROWT moves in a figure-eight upwind travel pattern at an upwind travel velocity.

20. The AROWT according to claim 19, wherein a net upwind hull speed to wind speed WS ratio is within the range of 0.001 to 0.2.

24. The AROWT according to claim 19, wherein a net upwind hull speed to wind speed WS ratio is within the range of 0.001 to 0.4.

22. An autonomous roaming offshore wind turbine (AROWT) comprising:
a floating hull;
a lifting keel extending outwardly from an underside of the hull;
ballast;
a propeller mounted to a portion of the hull; and
a wind turbine mounted to an upper side of the hull opposite the underside thereof;
wherein when deployed in a body of water, the AROWT moves in a figure-eight downwind travel pattern at a downwind travel velocity.

23. The AROWT according to claim 22, wherein a net downwind hull speed to wind speed WS ratio is within the range of 0.001 to 0.2.

24. The AROWT according to claim 22, wherein a net downwind hull speed to wind speed WS ratio is within the range of 0.001 to 0.4.
